(19) United States
(12) Patent Application Publication
(10) Pub. No.: US 2015/0319265 A1
(43) Pub. Date: Nov. 5, 2015

(54) UNIQUE IDENTIFIER FOR A TRANSACTION

(71) Applicant: HEWLETT-PACKARD DEVELOPMENT COMPANY, L.P., Houston, TX (US)

(72) Inventors: John DeRoo, Whitby (NZ); Trina R. Wisler-Krug, Tigard, OR (US); Narendra Goyal, Campbell, CA (US); Oliver S. Bucaojit, San Jose, CA (US); Shang-Sheng Tung, Cupertino, CA (US); Sean L. Broeder, Sunnyvale, CA (US); Adriana Carolina Fuentes, San Jose, CA (US); Ronald M. Cassou, Palo Alto, CA (US)

(73) Assignee: HEWLETT-PACKARD DEVELOPMENT COMPANY, L.P., Houston, TX (US)

(21) Appl. No.: 14/265,736

(22) Filed: Apr. 30, 2014

(51) Int. Cl. H04L 29/08

(52) U.S. Cl. CPC H04L 67/32; H04L 67/02

(57) ABSTRACT

A plurality of transaction domains include transaction managers owning respective transactions, where a first of the transactions is uniquely identified by a unique identifier that indicates a first of the transaction managers that owns the first transaction, the unique identifier relating to the transaction domain in which the first transaction manager is included. The first transaction manager receives a request from a requester that initiated the first transaction, the request sent to the first transaction manager based on the unique identifier of the first transaction.

### BACKGROUND

Data processing can be performed in a distributed computing environment that includes computer nodes. For a transaction, data processing can be performed in parallel by multiple computer nodes. To provide consistency and integrity of data that is processed in parallel by multiple computer nodes for the transaction, a central transaction manager can be provided to coordinate a commit of the transaction. A transaction commit applies data modifications made by the transaction and persists the data modifications to persistent storage.

### BRIEF DESCRIPTION OF THE DRAWINGS

Some implementations are described with respect to the following figures.

FIG. 1 is a block diagram of an example distributed computing environment according to some implementations.

FIG. 2 is a schematic diagram illustrating an operation in the distributed computed environment of FIG. 1, according to some implementations.

FIG. 3 is a flow diagram of a distributed transaction management process according to some implementations.

FIG. 4 is a flow diagram of a process of a lead transaction manager, according to some implementations.

FIG. 5 is a block diagram of an example computer node according to some implementations.

### DETAILED DESCRIPTION

A transaction can refer to a collection of one or multiple operations that are performed to provide a specified function. The transaction can be initiated in response to a request or multiple requests. Using a single central transaction manager to coordinate parallel processing (including commit) of a transaction in a distributed computing environment can reduce scalability. Scalability of the distributed computing environment refers to the ability of the processing capacity of the distributed computing environment to proportionately increase with an increase in processing resources (e.g. processors, computer nodes, memory, etc.).

In a distributed computing environment that is running a large number of transactions, the central transaction manager can become a bottleneck, such that adding processing resources to the distributed computing environment may not result in a desired proportionate increase in the processing capacity of the distributed computing environment to handle a workload. In some examples, it may be desirable to be able to linearly scale the distributed computing environment's ability to handle workload as additional processing resources are added. Linear scalability can refer to the ability of the processing capacity of the distributed computing environment to grow approximately linearly in relation with an increase in processing resources in the distributed computing environment.

In some examples, a transaction manager seeks to maintain the following properties for each transaction: atomicity, consistency, isolation, and durability. These properties can be referred to as ACID properties. To achieve the atomicity property, changes that a transaction makes to data are either all applied or are not applied at all. If a transaction aborts, then the state of the data will be as if the transaction never executed.

The consistency property seeks to ensure that a transaction transforms data from one valid state to another valid state, according to one or multiple specified rules. The isolation property seeks to ensure that even though transactions are executed concurrently, it appears to each transaction that all other transactions are executed either before or after the given transaction.

The durability property seeks to ensure that once a transaction has been committed, the transaction will remain so, even in the event of failure or other fault, such as power loss in the distributed computing environment, a crash of hardware or a program (in the form of machine-readable instructions), or a data error. In other words, the durability property seeks to ensure that changes made to data by a completed transaction are persistent.

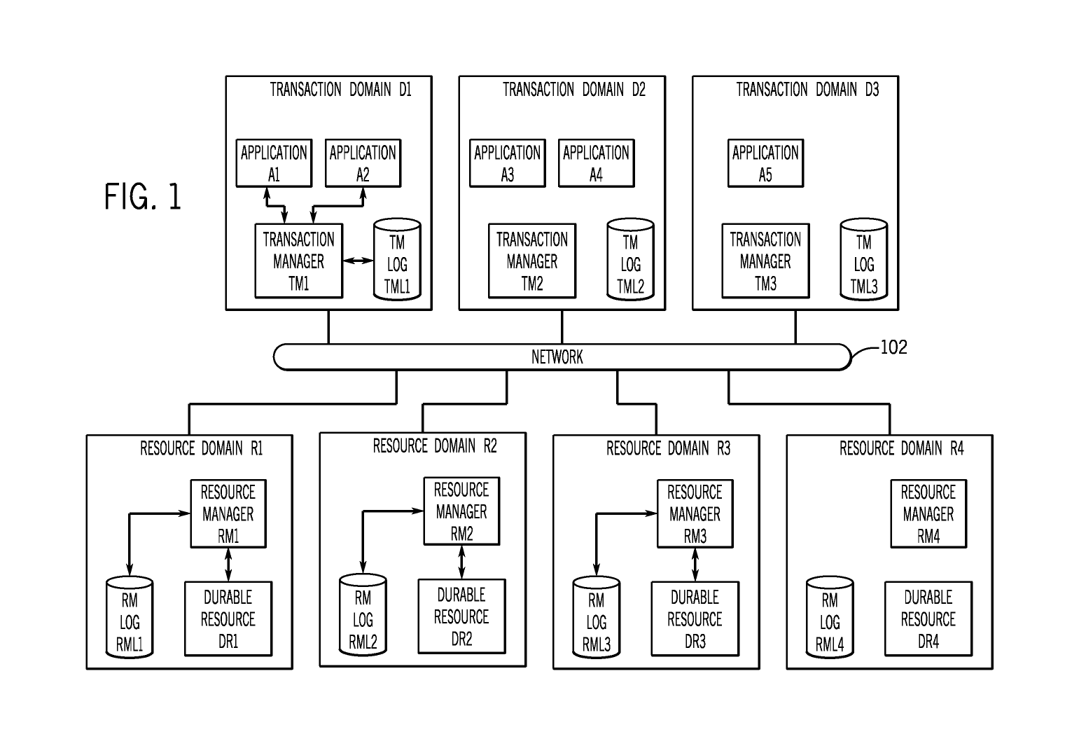

In accordance with some implementations, rather than employ a single central transaction manager, a distributed transaction management arrangement is provided in a system including a distributed computing environment. As shown in FIG. 1, the distributed computing environment is divided into multiple transaction domains, such as transaction domains D1, D2, and D3. Although three transaction domains are shown in FIG. 1, it is noted that in alternative examples, a distributed computing environment can include a different number of transaction domains, such as two transaction domains or more than three transaction domains.

A transaction domain can refer to a logical partition provided by a computing infrastructure that can include one or multiple computer nodes, where a computer node can refer to a computer, a collection of computers, a processor, or a collection of processors. Each logical partition can include a number of components that are involved in initiating and/or controlling a transaction. One of components included in each transaction domain is a transaction manager. In the example of FIG. 1, the transaction domains D1, D2, and D3 include respective transaction managers TM1, TM2, and TM3, which can be implemented as machine-readable instructions.

More generally, a transaction domain can refer to a partition within a distributed computing environment in which transaction management can be performed (by a respective transaction manager). As discussed further below, unique identifiers can be produced for each transaction based on which transaction domain provides transaction management for the respective transaction. More generally, the unique identifier of a transaction relates to a corresponding transaction domain.

A transaction manager owns a transaction that is started in the respective transaction domain. In some implementations, a transaction manager owns a transaction if the transaction manager is responsible for ensuring one or multiple target properties of the transaction, such as the ACID properties or a subset of the ACID properties discussed above. Each transaction manager is aware of the transactions the transaction manager owns. The transaction managers do not interact (e.g. communicate) with each other regarding coordination of transactions.

The presence of multiple transaction managers TM1, TM2, and TM3 in respective transaction domains D1, D2, and D3 allows for distributed control of transactions by different transaction managers. Stated differently, the arrangement shown in FIG. 1 allows for transaction management to be performed by multiple transaction managers for respective transactions, such that centralized transaction management does not have to be provided. In this manner, scalability is enhanced, since additional transaction domains can be added to the distributed computing environment to increase the processing capacity of the distributed computing environment. In some examples, approximate linear scalability may be achieved.

In the example arrangement of FIG. 1, each transaction domain D1, D2, or D3 also includes one or multiple applications and a transaction manager (TM) log. In a specific example, the transaction domain D1 includes applications A1 and A2 and a TM log TML1, the transaction domain D2 includes applications A3 and A4 and a TM log TML2, and the transaction domain D3 includes an application A5 and a TM log TML3. An application can be implemented as machine-readable instructions that are able to send a request (or requests) for initiating a transaction. More generally, each transaction domain can include a requester that is able to send request(s) to initiate a transaction.

Examples of applications can include applications for a No-SQL (No Structured Query Language) system, an application for a relational database management system, or another type of application. A No-SQL system provides for storage and processing of data using data structures other than relations (tables) that are used in relational databases. Examples of data structures that can be used to store data in a No-SQL system include trees, graphs, key-value data stores, and so forth. In contrast, a relational database management system stores data in relations, which are accessed using SQL queries.

Although reference is made to applications for various types of systems according to some examples, it is noted that in other examples, techniques or mechanisms according to some implications can be applied to other types of systems.

The distributed computing environment of FIG. 1 also includes resource domains R1, R2, R3, and R4. The transaction domains D1, D2, and D3 are coupled to the resource domains R1, R2, R3, and R4 over a network 102, such as the Internet, a local area network (LAN), a wide area network (WAN), a virtual private network (VPN), and so forth. Although a specific number of resource domains are shown in the example of FIG. 1, note that in other examples, a different number of resource domains can be employed. Each resource domain is a logical partition in the distributed computing environment that includes a resource upon which a transaction is applied. Multiple resource domains can be involved in a transaction.

Each resource domain R1, R2, R3, or R4 includes a respective resource manager RM1, RM2, RM3, or RM4, which can be implemented as machine-readable instructions. A resource manager manages a group of at least one durable resource (e.g. DR1, DR2, DR3, or DR4), such as a table, a file, or any other resource upon which a transaction can be applied. A durable resource refers to a resource that is persistent (in other words, the resource is not lost when power is removed from a system. More generally, a resource can include data on which a transaction is to be performed. A resource manager is responsible for consistency of resources owned by the resource manager. In some examples, a set of resources owned by one respective resource manager is not shared with other resource managers.

As further shown in FIG. 1, each resource domain R1, R2, R3, or R4 further includes a respective resource manager (RM) log RML1, RML2, RML3, or RML4. An RM log persistently stores data modifications that have not yet been committed. The content of the RM log can be accessed to replay data modifications as part of failure recovery. Each RM log can be stored in persistent storage.

Each transaction manager log (TML1, TML2, or TML3) in a respective transaction domain D1, D2, or D3 stores state information of the respective transaction manager TM1, TM2, or TM3 in a persistent manner, to allow for recovery from an event in the distributed computing environment that causes a transaction to crash. The event can include a failure or other fault of hardware and/or machine-readable instructions, a power loss, a data error, and so forth. Each TM log can be stored in persistent storage.

The state information stored in a TM log can include a commit record, which stores information usable by the transaction manager to inform resource manager(s) involved in a transaction of a point in a commit process that each resource manager was at when the event that led to the transaction crash occurred. A commit process can be according to a two-phase commit protocol, which coordinates resource managers involved in a transaction to commit or abort a transaction. The two-phase commit protocol includes a prepare phase and a commit phase. In the prepare phase, the transaction manager attempts to prepare the resource managers to take actions for either committing or aborting the transaction. In the commit phase, the transaction manager decides whether to commit or abort the transaction, and notifies the resource managers of the decision.

In accordance with some implementations, globally unique transaction identifiers are used to allow for identification of a respective transaction manager that owns the corresponding transaction. More generally, the globally unique transaction identifier indicates the transaction manager that owns a given transaction. This globally unique transaction identifier can be used by an application, a resource manager, or other entity to ascertain which of the multiple transaction managers within the distributed computing environment is the transaction manager that owns the given transaction. Thus, the globally unique transaction identifier can be used to locate a specific transaction domain within the distributed computing environment without having to access a central coordinator.

A globally unique transaction identifier for a given transaction is related to a transaction domain that includes the transaction manager owning the given transaction. More specifically, the globally unique transaction identifier for the given transaction is based on information of the transaction domain. In some examples, a globally unique transaction identifier can be based on a combination of a transaction domain identifier (which identifies a respective transaction domain) and a local transaction identifier (which identifies a transaction). Within each transaction domain, local transaction identifiers are generated locally by the respective transaction manager. The local transaction identifiers generated within a given transaction domain are unique within the given transaction domain (but may not be unique across transaction domains).

In some examples, a globally unique transaction identifier can be a tuple (D, T), where D is the transaction domain identifier, and T is the local transaction identifier. In such examples, the globally unique transaction identifier is a concatenation of the transaction domain identifier and the local transaction identifier. In other examples, other types of combinations of a transaction domain identifier (D) and a local transaction identifier (T) can be performed to produce a globally unique transaction identifier for a transaction. For example, a function can be applied to D and T to produce an output value that is the globally unique transaction identifier.

For a given transaction, one or multiple applications involved in the transaction can invoke one or multiple resource managers (RM1, RM2, RM3, and/or RM4) to be participants in the transaction. A resource manager that is a participant in the transaction refers to a resource manager that performs work for the transaction on a respective durable resource managed by the resource manager.

A registration is performed with an owning transaction manager (the transaction manager that owns a given transaction) to allow the owning transaction manager to track the resource manager(s) that is (are) participant(s) in the given transaction. The registration can be a process in which a notification is provided to the owning transaction manager participating resource manager(s) in the given transaction.

The registration with the owning transaction manager can be performed by each resource manager that participates in the given transaction, or alternatively, the registration can be performed by a separate entity (discussed further below). Once resource managers are registered with the owning transaction manager, the owning transaction manager can coordinate a commit or abort of the given transaction.

As further shown in FIG. 1, each application is associated with a respective TM library and an RM library. A TM library provides a programming interface (such as an application programming interface or API) to a respective application. The TM library can provide a programming interface (which can include routines that can be invoked by another entity) to which an application can submit respective requests. In response to requests from the application, the TM library can send corresponding requests to the transaction manager. The request that is sent by a TM library to a transaction manager in response to application requests can include a transaction begin request (to begin a transaction), a commit request (to start a commit process), a rollback request (a request to rollback data to a prior state), or other requests.

An RM library provides a programming interface (e.g. an API) which allows for an application to send requests to a respective resource manager to perform requests associated with durable resources managed by the resource managers. The requests can include requests to modify data (insert data, update data, or delete data), requests to join data, requests to sort data, and so forth.

As noted above, registration of a resource manager as a participant can be performed by the resource manager with the transaction manager. This can be accomplished by the resource manager submitting a registration request with the transaction manager. Alternatively, the registration request can be issued by an RM library in response to a request from a corresponding application to a resource manager to perform work in a transaction.

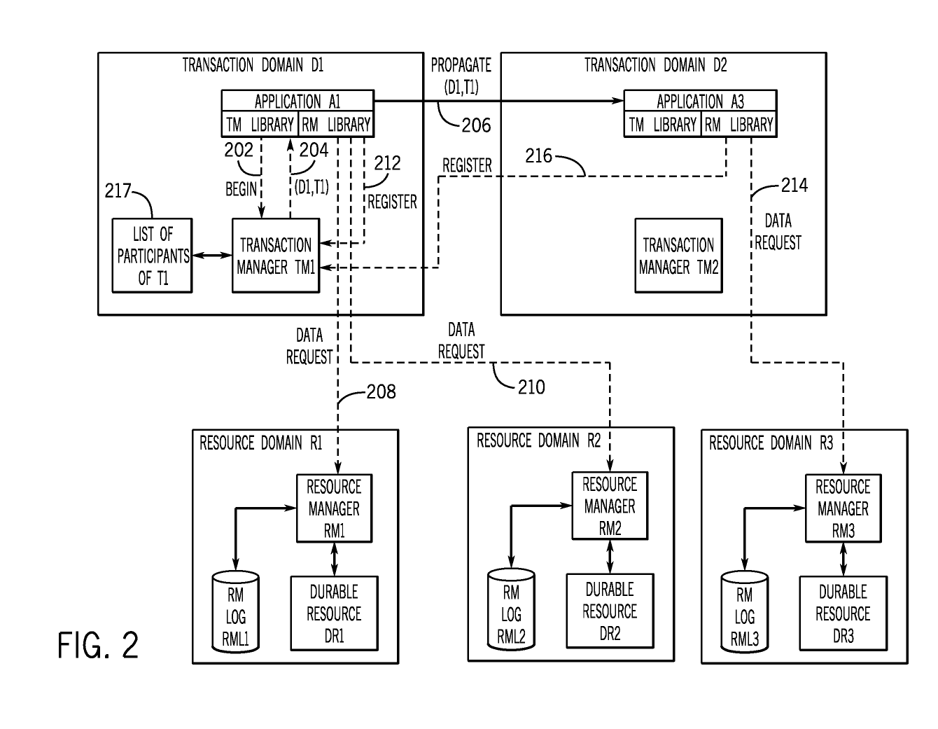

FIG. 2 shows an example of performing a transaction. Some of the components depicted in FIG. 1 are shown in FIG. 2. As an example, it is assumed that application A1 wishes to begin a given transaction. Application A1 can send a begin request (202) to the transaction manager TM1 (through the respective TM library). In response to the begin request (202), the transaction manager TM1 returns a globally unique transaction identifier (D1, T1) (204) to application A1 (through the TM library). D1 is the transaction domain identifier of transaction domain D1, and T1 is the local transaction identifier generated by the transaction manager TM1 for the requested transaction (transaction T1). Application A1 (or the TM library or RM library of application A1) can use the globally unique transaction identifier (D1, T1) to determine which transaction manager owns transaction T1. In some implementations, the TM library and/or the RM library associated with each application can route a request to the appropriate transaction manager, based on the globally unique transaction identifier.

Assuming that application A3 (in the transaction domain D2) is also to be involved in transaction T1, the globally unique transaction identifier (D1, T1) received by application A1 from the transaction manager TM1 can be propagated (206) to application A3. Application A3 (or the TM library and/or RM library of application A3) can similarly use the globally unique transaction identifier (D1, T1) to determine which transaction manager owns transaction T1.

Each of applications A1 and A3 can perform data operations of transaction T1 with respect to various resources managed by corresponding resource managers. As an example, application A1 can send data requests (208, 210) to resource managers R1 and R2, through the respective RM library, to perform data operations of transaction T1. The data requests sent to the resource managers R1 and R2 can include the globally unique transaction identifier (D1, T1), in some examples.

In response to each data request sent to each of resource managers R1 and R2, the RM library can issue a respective registration request (212) to transaction manager TM1 to register resource managers R1 and R2 with transaction manager TM1. The RM library is able to determine that the transaction manager TM1 owns transaction T1 based on the globally unique transaction identifier (D1, T1). In other examples, as noted above, the resource managers R1 and R2 can send registration requests to the transaction manager TM1. In the latter examples, an RM library can be bound to a resource manager rather than an application (as shown in FIG. 2), such that the RM library can be used to issue a registration request when the resource manager receives a data request for a transaction that the resource manager is not aware of.

Similarly, application A3 can issue a data request (214) to the resource manager RM3 to perform a data operation of transaction T1. In response to the data request (214), the RM library associated with application A3 can submit a corresponding registration request (216) to the transaction manager TM1 to register that resource manager RM3 with the transaction manager TM1.

Upon receiving the registration requests (212, 216), the transaction manager TM1 can maintain a list 217 of participants in transaction T1. This list 217 of participants (which can include identifiers of resource managers that are participants in transaction T1) can be used by the transaction manager TM1 to manage commitment of transaction T1 or recover with respect to transaction T1. With the list 217 of participants, the transaction manager TM1 can determine the resource managers that are involved in committing transaction T1, or in performing a recovery with respect to transaction T1. The list 217 of participants can be stored in a memory accessible by the transaction manager TM1.

In response to the data requests from applications A1 and A3, the respective resource managers can perform the requested work with respect to the corresponding durable resources (e.g. DR1, DR2, DR3, etc.). Note that registration is to be performed only once for each resource manager requested to perform work on behalf of transaction T1.

Once the resource managers have completed their respective work, each resource manager can provide an indication of the completion of the work back to the application (A1 or A3 in the FIG. 2 example) that sent the respective data request. Application A3 can also forward the indication of completion of the work performed by the resource manager RM3 back to application A1. Once application A1 determines that all requested work has been completed by the participating resource managers, the initiating application (application A1) that began transaction T1 can send a commit request to transaction manager TM1 to commit the transaction. Application A1 can determine that the transaction manager TM1 owns transaction T1 based on the globally unique transaction identifier (D1, T1) assigned to transaction T1.

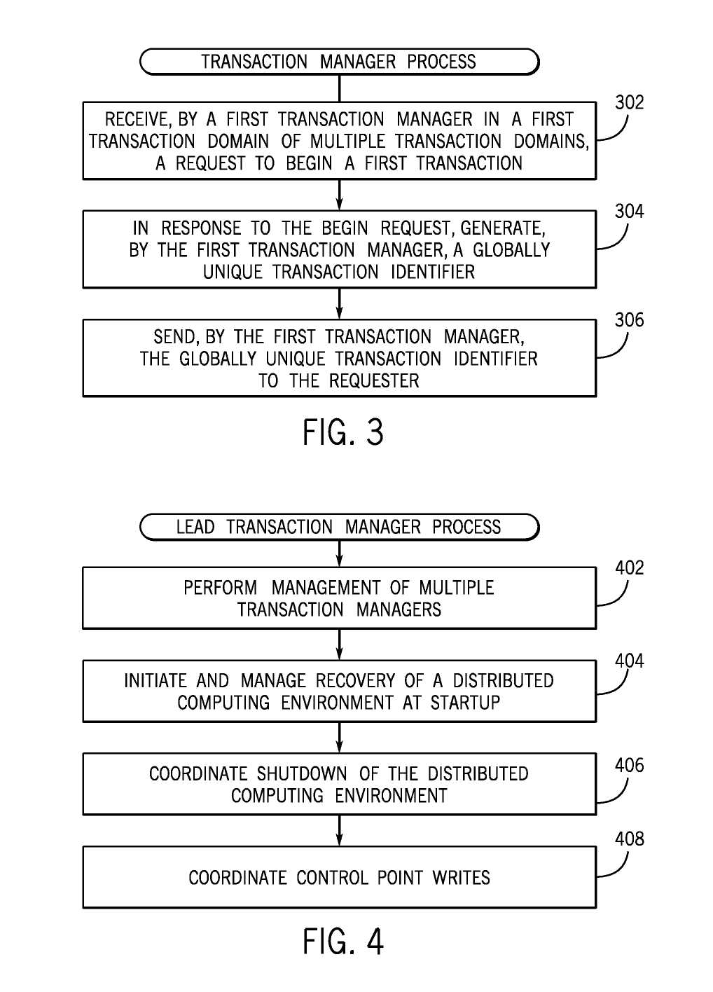

FIG. 3 is a flow diagram of a transaction manager process according to some implementations. A first transaction manager (e.g. TM1) in first transaction domain (e.g. D1) of multiple transaction domains can receive (at 302) a request from a requester (e.g. application A1) to begin a first transaction (e.g. T1).

In response to the begin request, the first transaction manager generates (at 304) a globally unique transaction identifier based on a domain identifier (e.g. D1) of the first transaction domain and a local transaction identifier (e.g. T1) generated by the first transaction manager for the first transaction. This globally unique transaction identifier can be (D1, T1), for example.

The first transaction manager sends (at 306) to the requester the globally unique transaction identifier for use by the requester.

In some implementations, one of the transaction managers in the distributed computing environment can be designated to be a lead transaction manager. The lead transaction manager is not involved in transaction management of transactions owned by other transaction managers. However, the lead transaction manager is responsible for coordinating certain actions with other transaction managers.

FIG. 4 is a flow diagram of certain operations of a lead transaction manager. The lead transaction manager can perform (at 402) management of multiple transaction managers—for example, the lead transaction manager can check the status of other transaction managers to ensure that the other transaction managers are running. If any particular transaction manager fails or otherwise is deactivated, the lead transaction manager can restart the particular transaction manager. For example, the particular transaction manager may be running on a computer node that has failed. In this example, the lead transaction manager can restart the particular transaction on another computer node.

The lead transaction manager can also initiate and manage (at 404) recovery of the distributed computing environment at startup. Although each transaction manager is responsible for the transaction manager's own transaction recovery at startup, the lead transaction manager can coordinate, as part of the startup procedure, when an application can begin to use a service provided by a certain transaction manager.

The lead transaction manager can also coordinate (at 406) shutdown of the distributed computing environment. The coordination provided by the lead transaction manager provides a clean point for restarting the distributed computing environment, such as by storing state information of the distributed computing environment from which the distributed computing environment can restart.

The lead transaction manager can also coordinate (at 408) control point writes across the transaction managers of the distributed computing environment. At specified points (e.g. periodically, intermittently, etc.), the lead transaction manager can send a control point request to the transaction managers to cause the transaction managers to flush the states of respective transactions (e.g. including data updates of the transactions) to corresponding TM logs (e.g. TML1, TML2, and TML3 in FIG. 1). Flushing a state of a transaction to a persistent data structure such as a TM log can refer to performing a control point write. The flushed states of the transactions can be used to perform recovery in case of failure.

In some examples, although a transaction manager may maintain a list of identifiers of resource managers that are participants in a given transaction (e.g. list 217 shown in FIG. 2) in response to registrations performed to indicate which resource managers are the participants, the transaction manager may not store the identifiers of resource managers that are participants in the given transaction in the respective TM log. Such identifiers of the resource managers are part of “subordinate branch information” of the given transaction. Avoiding the write of subordinate branch information associated with commits to a TM log can reduce the size of each TM log since branch information can be quite extensive.

If the subordinate branch information is not stored in the TM logs, then at startup of the distributed computing environment, each transaction manager would have to contact all resource managers to determine a list of “indoubt” transactions, which are transactions that may not have completed at the time the distributed computing environment crashed or was shut down. The indoubt transactions can be reinstated (replayed), and after doing so, new transactions can be allowed to proceed. Note that all resource managers would have to be contacted at startup before a transaction can be forgotten.

In other examples, the subordinate branch information can be stored in each TM log.

In some implementations, in a distributed computing environment that includes transaction domains according to some implementations, time clock synchronization does not have to be performed across computer nodes on which the transaction domains are implemented. Time clock synchronization can refer to synchronizing time clocks of different computer nodes. Since the TM logs (e.g. TML1, TML2, and TML3) and RM logs (e.g. RML1, RML2, RML3, and RML4) are owned by their respective transaction managers and resource managers, respectively, repeatability replay of transactions and thus consistency across the distributed computing environment can be achieved without time clock synchronization.

However, in other implementations, time clock synchronization can be implemented.

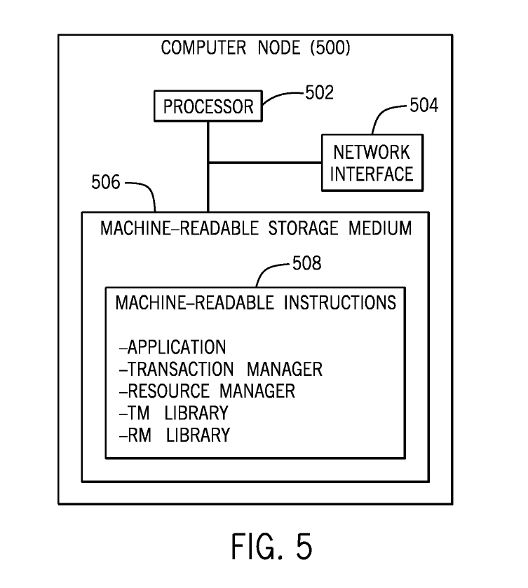

FIG. 5 is a block diagram of a computer node 500 according to some implementations. One or multiple computer nodes 500 can be used to implement the transaction domains and resource domains of FIG. 1. The computer node 500 includes one or multiple processors 502, which can be coupled to a network interface 504 (for communications over a network) and a non-transitory machine-readable or computer-readable storage medium (or storage media) 506. A processor can include a microprocessor, microcontroller, processor module or subsystem, programmable integrated circuit, programmable gate array, or another control or computing device. The storage medium (or storage media) 506 can store machine-readable instructions 508, which can include an application, a transaction manager, and/or a resource manager as discussed above.

The storage medium (or storage media) 506 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
at least one computer;
a plurality of transaction domains provided by the at least one computer and including transaction managers owning respective transactions, wherein a first of the transactions is uniquely identified by a unique identifier that indicates a first of the transaction managers that owns the first transaction, the unique identifier relating to the transaction domain in which the first transaction manager is included,
wherein the first transaction manager is to receive a request from a requester that initiated the first transaction, the request sent to the first transaction manager based on the unique identifier of the first transaction.

2. The system of claim 1, wherein the request from the requester is a commit request to commit the first transaction.

3. The system of claim 1, wherein the transaction domains are uniquely identified by respective transaction domain identifiers, and each unique identifier of a respective one of the transactions is based on a combination of a respective one of the transaction domain identifiers and a transaction identifier of the respective transaction produced by the corresponding transaction manager.

4. The system of claim 1, further comprising resource managers, wherein a first one of the resource managers is to receive a data request from the requester to perform work of the first transaction with respect to a resource managed by the first resource manager.

5. The system of claim 4, wherein the first transaction manager is to receive a registration request indicating that the first resource manager is participating in the first transaction.

6. The system of claim 5, wherein the first resource manager is to send the registration request to the first transaction manager based on the unique identifier.

7. The system of claim 5, further comprising a programming interface associated with the requester, wherein the programming interface is to send the registration request to the first transaction manager, based on the unique identifier, in response to the requester sending the data request to the first resource manager.

8. The system of claim 1, further comprising the requester, wherein the requester includes an application.

9. A method comprising:
receiving, by a first transaction manager in first transaction domain of a plurality of transaction domains that include respective transaction managers that own corresponding transactions, a request from a requester to begin a first transaction;
in response to the request, generating, by the first transaction manager, a unique identifier based on a domain identifier of the first transaction domain and a transaction identifier generated by the first transaction manager for the first transaction; and
sending, by the first transaction manager to the requester, the unique identifier for use by the requester.

10. The method of claim 9, further comprising receiving a request by the first transaction manager, the request sent to the first transaction manager based on the unique identifier.

11. The method of claim 9, wherein the request is a registration request that identifies a resource manager involved in the first transaction, the resource manager to manage a resource with respect to which the first transaction is involved.

12. The method of claim 9, wherein the request is a request to commit the first transaction or a request to rollback the first transaction.

13. The method of claim 9, further comprising interacting, by the first transaction manager, with a lead transaction manager that coordinates management of a plurality of transaction managers, the management selected from the group consisting of restarting a transaction manager, managing startup of a system including the plurality of transaction managers, coordinating shutdown of the system, and coordinating control point writes of states of the plurality of transaction managers.

14. An article comprising at least one non-transitory machine-readable storage medium storing instructions that upon execution cause a system to:
generate unique identifiers for transactions in the system comprising a plurality of transaction domains that include respective transaction managers, each of the unique identifiers being based on a domain identifier of a respective one of the transaction domains and a local transaction identifier generated for the respective transaction by the corresponding transaction manager, wherein the transaction managers own the respective transactions and do not interact with each other in management of the transactions;
receive, by a first of the transaction managers, registration requests to register resource managers involved in a first of the transactions, the resource managers to manage respective resources with respect to which the first transaction is to be performed, the registration requests sent to the first transaction manager based on the unique identifier of the first transaction; and
receive, by the first transaction manager, a request to commit or rollback the first transaction, the request to commit or rollback sent to the first transaction manager based on the unique identifier of the first transaction.

15. The article of claim 14, wherein the instructions upon execution cause the system to further:
produce, by the first transaction manager based on the registration requests, a list of the resource managers involved in the first transaction; and
use, by the first transaction manager, the list to commit or rollback the first transaction.
